(19) United States
(12) Patent Application Publication
(10) Pub. No.: US 2008/0154794 A1
(43) Pub. Date: Jun. 26, 2008

(54) SYSTEM AND METHOD FOR DETERMINING PROFITABILITY OF STOCK INVESTMENTS

(76) Inventor: Peter J. JOHANSSON, Greenwich, CT (US)

Correspondence Address: ST. ONGE STEWARD JOHNSTON & REENS, LLC, 986 BEDFORD STREET, STAMFORD, CT, 06905-5619, US

(21) Appl. No.: 11/957,703

(22) Filed: Dec. 17, 2007

Related U.S. Application Data
(60) Provisional application No. 60/871,676, filed on Dec. 22, 2006.

(51) Int. Cl. G06Q 40/00; G06F 17/10

(52) U.S. Cl. 705/36 R

(57) ABSTRACT

A system and method for determining profitability on stock investments. The method includes determining or calculating a fair value of a particular stock (which may further include taking into account risk), determining or calculating the annual compounding intrinsic growth of the company, determining or calculating the consistency of the intrinsic growth (such as risk); and generating the current annual compounding rate of return on investment.

### CROSS-REFERENCE TO RELATED APPLICATIONS

The present application claims the benefit under 35 U.S.C. §119(e) of the U.S. Provisional Patent Application Ser. No. 60/871,676, filed on Dec. 22, 2006, the content of which is incorporated herein by reference.

### FIELD OF THE INVENTION

The invention relates to a system and method for analyzing stock investments and more particularly, to a system and method for determining profitability on stock investments.

### BACKGROUND OF THE INVENTION

Individuals have been trying to accurately determine the value of stocks for many decades with limited success. A number of these systems and methods are discussed below.

For example, U.S. Patent Publication No. 2005/0187851 A1 (Sant) discloses a financial portfolio management and analysis system and method, which includes several different modules, one of which is a stock valuation module. This module receives a user specified ticker symbol for a specified stock and a beta estimation period, and reaches into a historical stock price database. After extracting returns for the index and the specified stock for the specified period, the module econometrically computes the beta of the stock. It combines the computed beta with the risk free rate (T-Notes) stored in a database and produces a discount rate for the specified stock. The module automatically fills in the most recent dividend paid by the stock, which dividend is extracted from a live stock data feed. After the user provides the growth rate(s) or dividends, the module estimates the current value of the stock. It also projects a future value for the stock at the end of the specified charting period and displays the results in a tabulated as well as graphical format. The stock value is computed based upon one of three formulas (constant growth, super growth or unequal dividends) as specified in the Sant reference at page 11, paragraphs 265 through 269.

Another example is U.S. Patent Publication No. 2006/0277132 A1 (Brooks) which discloses a system for aiding investors in analyzing the attributes of investments, such as stocks, by graphically displaying the relative positions of investments with respect to one another and with respect to selectable evaluation parameters and benchmarks for such investments. More specifically, the system defines data dimensions by which locations of investments will be analyzed and presented in graphical fashion, defines data sources from which attributes of the investments will be selected, and presents, in a graphical framework, the investments as a function of the defined dimensions according to locations defined by each investment's respective attributes. Examples of the various dimensions which may be used to provide the graphical presentation include momentums, valuations and other dimensions, examples of which are provided in the Brooks reference at page 4, paragraphs 35 and 36.

Both Sant and Brooks disclose systems which purport to aid investors in evaluating the profitability of stock investments. However, neither Sant nor Brooks discloses a system and method that provide for a calculation of a current annual compounding rate of return on investment that is highly accurate and repeatably predictable. Operations that do not meet these requirements are unacceptably speculative and are not able to properly determine a value for the investment.

In addition, neither reference adjusts a fair value of stocks in a population in order to yield a current annual compounding rate of return on investment comparable to the stock in the population having the highest current annual compounding rate of return on investment.

### SUMMARY OF THE INVENTION

What is desired then is a highly accurate and predictable system and method for determining the value of stock investments.

It is further desired to provide a system and method that adjusts a fair value of stocks in a population in order to yield a current annual compounding rate of return on investment comparable to the stock in the population having the highest current annual compounding rate of return on investment.

These and other objects are achieved by the provision of a system and method for determining the profitability of stock investments, which are provided below.

A method in accordance with the present invention includes four major steps: 1) determining the fair value of a particular stock; 2) determining the annual compounding intrinsic return of the company; 3) determining the consistency of the intrinsic return; and 4) determining the current annual compounding rate of return on investment. While step 1 is listed separate from step 3, it is contemplated that these steps could be combined.

“Fair value” for this application is defined as the relative value to the risk free rate of, for example, a ten-year US Treasury Note. For earnings, the previous years Generally Accepted Accounting Principles (GAAP) earnings are used. Alternatively, the consensus earnings estimate for the current year may be used.

“Risk Free Rate” is defined as the best competitive rate of return that does not involve taking a risk. Both the return of the original capital and the payment of interest are certain. For this application the “Risk Free Rate” may be defined the current rate or alternatively as the average rate during a period, or a historical rate. In a preferred embodiment, a current ten-year US Treasury note rate represents the risk free rate.

“Rolling Earnings per Share (EPS)” for this application is defined as measuring a company's EPS by using the previous two quarters and adding them to the following two quarter's estimated EPS.

Optionally, step 3 could be combined with step 1. As used in this application, “risk” is defined as the consistency ratio expressed as a factor on the company's ten-year historical annual compounding earning return (intrinsic return). A consistency ratio factor of (0) indicates a 100% consistent return record. When determining the fair value, the consistency ratio multiplied with the risk free rate is the risk premium. The risk premium is added to the risk free rate to create a new discount rate as noted below.

Annual compounding earning return (intrinsic return) is defined and determined by a historical annual compounding rate of return of a company's relative value to the risk free rate (e.g. a ten-year Treasury Note) taking dividends and other distributions into consideration. The relative value (fair value) is calculated by dividing the annual Earnings Per Share (EPS) with the risk free rate. Dividends or other distributions are the accumulated payments during the period (duration) extending from time t₁ to time tₙ.

Consistency of intrinsic return is defined and determined by the consistency ratio of the ten-year historical annual compounding return rate in earnings. It is determined by the consistency ratio of the ten year historical annual or quarterly (year by year growth rate records) compounding intrinsic return. The consistency ratio is expressed as a factor—Relative Strength Differential is calculated to get a measure of relative risk. Higher consistency ratio translates to higher risk and vice versa. Again, this step may be combined with the step of determining a fair value for the particular stock.

Current annual compounding rate of return on investment is determined by calculating the annual compounding rate of return between current stock price and the ten-year calculated intrinsic value.

It is additionally contemplated that a method for determining fair value for a stock from a competitive perspective can be provided. This method may be used in conjunction with the method described above. For example, the method could further include determining fair value of stocks in a population (index) based on a ranking system where a computer system, at any given moment, calculates the number one ranked company based on its “Current Annual Compounding Rate of Return on Investment” according to the above-described method.

In one advantageous embodiment a method for determining the profitability on stock investments is provided comprising the steps of calculating the fair value of a stock by dividing a per share earnings of the stock by a risk free rate during a period of time (t) beginning at time (t₁) and ending at time (tₙ). The method further includes the step of calculating the annual compounding intrinsic return by adding a calculated fair value of the stock at time (tₙ) with the sum of payments and distributions during the period of time (t) and dividing the sum by a calculated fair value at time (t₁). The method still further includes the step of determining the consistency of intrinsic return rate by dividing a standard deviation comparison of the intrinsic return for discrete periods of time during time (t) by a historical annual compounding intrinsic return over time (t). Finally, the method includes the step of generating the current annual compounding rate of return on investment for the stock by dividing the future value by the current stock price, where the future value is a company's historical relative value to the risk free rate at time (tₙ).

In another advantageous embodiment a system for determining the profitability on stock investments is provided comprising a computer having a network connection, a database of information relating to stocks and accessible by the computer and software executing on the computer calculating the fair value of a stock by dividing a per share earnings of the stock by a risk free rate during a period of time (t) beginning at time (t₁) and ending at time (tₙ). The system further comprises software executing on the computer calculating the annual compounding intrinsic return by adding a calculated fair value of the stock at time (tₙ) with the sum of payments and distributions during the period of time (t) and dividing the sum by a calculated fair value at time (t₁). The system still further comprises software executing on the computer determining the consistency of intrinsic return rate by dividing a standard deviation comparison of the intrinsic return for discrete periods of time during time (t) by a historical annual compounding intrinsic return over time (t). Finally, the system comprises software executing on the computer generating the current annual compounding rate of return on investment for the stock by dividing the future value by the current stock price, where the future value is a company's historical relative value to the risk free rate at time (tₙ).

In still another advantageous embodiment a method for determining the profitability on stock investments is provided comprising the steps of calculating the fair value of a stock according to the following equation:

$$\frac{Rolling EPS}{Last 5 Days Average Risk Free Rate}$$

where Rolling EPS is Rolling Earnings Per Share (EPS) and is a measurement of a company's EPS by using the previous two quarters and adding them to the following two quarter's estimated EPS. The method further comprises the step of calculating the annual compounding intrinsic return according to the following equation:

$${( \frac{Future Value + Accumulated Distributions}{Present Value} )}^{( \frac{1}{n} )} - 1$$

where Future Value is a company's historical relative value to the risk free rate at the end of a ten-year period; Accumulated Distributions is the sum of dividend payments and other distributions during the ten-year period; and Present Value is a company's historical relative value to the risk free rate at the beginning of the ten-year period. The method further comprises the step of determining the consistency of intrinsic return rate according to the following equation:

$$Consistency = \frac{Standard Deviation of 10 Yr ( Year by Year Growth Records ) of the Relative Value to the Risk Free Rate}{10 Yr Annual Compounding Intrinsic Return}$$

and generating the current annual compounding rate of return investment according to the following equation:

$${( \frac{Future Value}{Current Price} )}^{( \frac{1}{n} )} - 1$$

where Current Price is the current stock price.

Other objects of the invention and its particular features and advantages will become more apparent from consideration of the following drawings and accompanying detailed description.

### BRIEF DESCRIPTION OF THE DRAWINGS

FIG. 1 is a graph illustrating a current annual return on investment illustrating the primary method.

FIG. 1A is a graph illustrating a first alternative method of the present invention.

FIG. 1B is a graph illustrating a second alternative method of the present invention.

FIG. 2 is a population chart illustrating a ranking of stocks listed from highest current annual compounding rate of return on investment to lowest.

FIG. 3 is a population chart according to FIG. 2 illustrating adjusted fair values for the stocks.

FIG. 4 is a block diagram illustrating a system in accordance with the methods described in connection with FIGS. 1, 1A and 1B.

FIG. 5 is a chart illustrating the current annual return on investments according to FIGS. 1, 1A and 1B.

FIGS. 6 through 9 are charts illustrating an index of companies listed by current annual return on investment according to FIGS. 1, 1A, 1B and 3.

FIGS. 10 and 11 are charts illustrating various consistency of Intrinsic returns showing higher and lower consistency ratios.

### DETAILED DESCRIPTION OF THE INVENTION

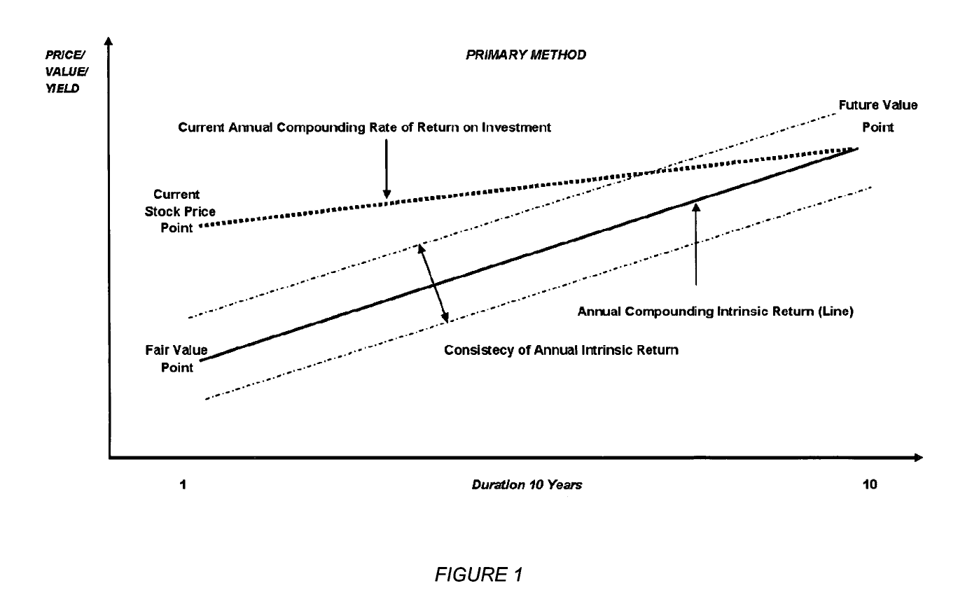

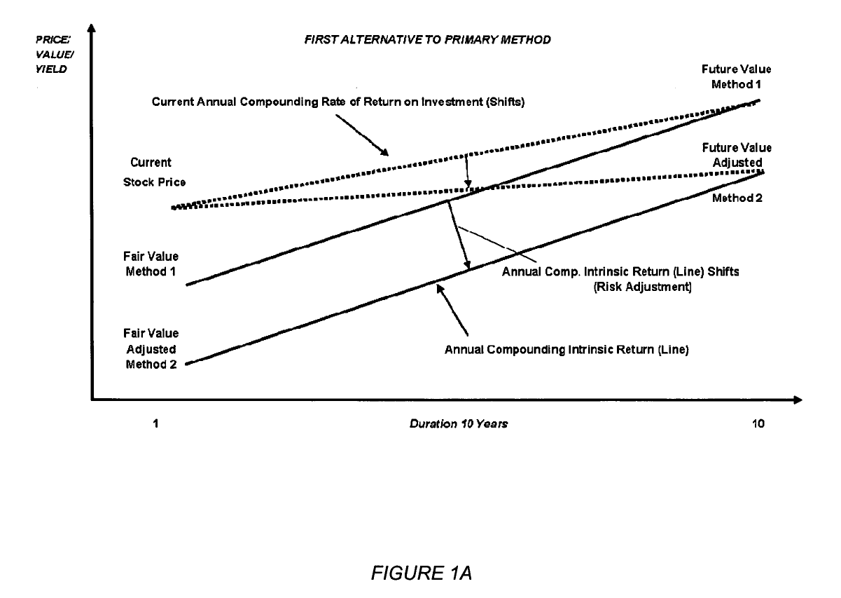

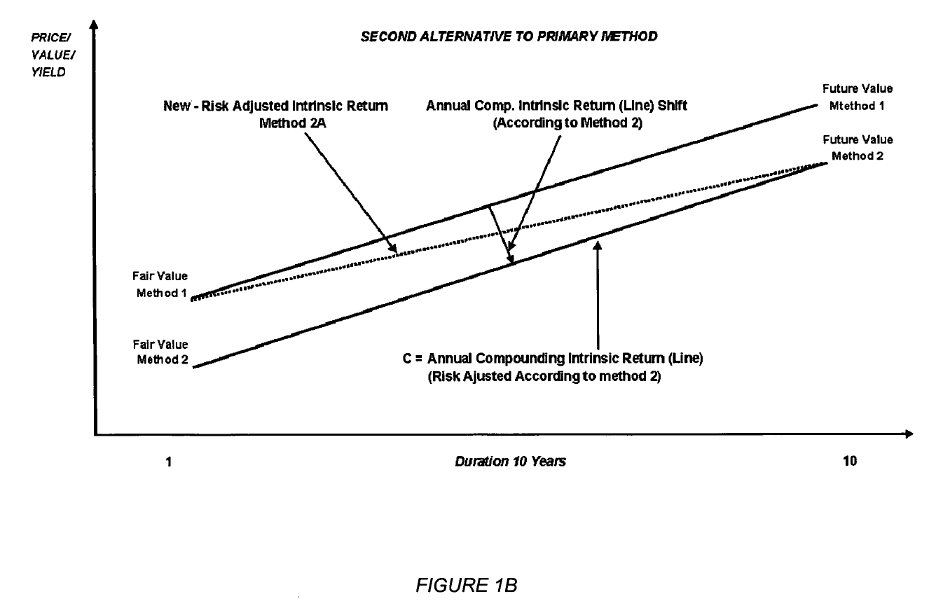

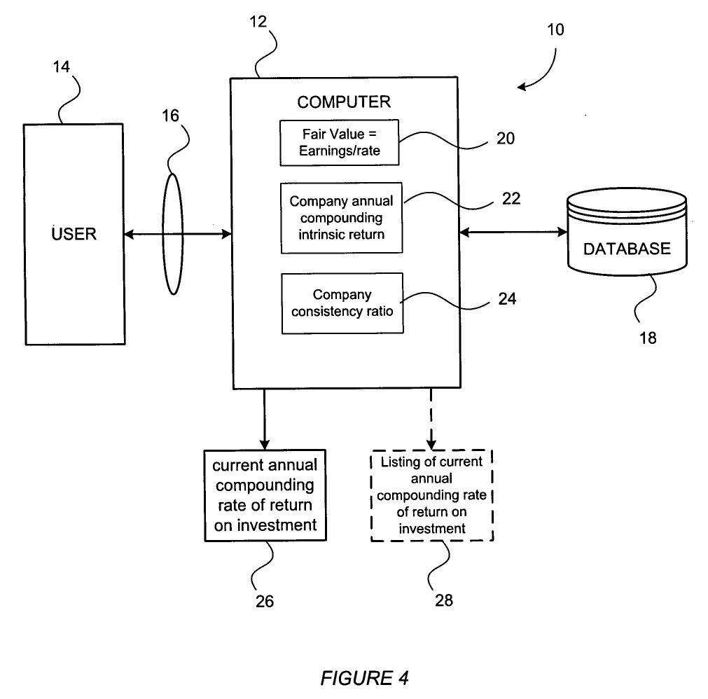

Provided herein is a system and method for determining profitability on stock investments. The method is generally described in an advantageous embodiment as provided below and further illustrated in FIGS. 1-3 and 5-9 while the system is generally illustrated in FIG. 4.

The method may include four steps: 1) determining the fair value of a particular stock; 2) determining the annual compounding intrinsic return of the company; 3) determining the consistency of the intrinsic return; and 4) determining the current annual compounding rate of return on investment. Alternatively, it is contemplated that the step of determining consistency of the intrinsic return may be performed during step 1, such that the step of determining a fair value of a particular stock takes into account the risk involved.

Primary Method (FIG. 1), step one: Current Fair Value Determination. For this application, “fair value” is the relative value to the risk free rate of a Treasury Note. In one advantageous embodiment, the Treasury Note could be a ten-year note. For earnings, the previous year's Generally Accepted Accounting Principles (GAAP) earnings may be used. Alternatively, the consensus earnings estimate for the current year could be used.

$$\begin{matrix}Fair Value = \frac{Rolling EPS}{Last 5 Days Average Risk Free Rate} \\ Example \text{:} & Equation 1 \\ Hennes \& Mauritz = \frac{SEK 16.5}{4.7 \%} = SEK 351 & \end{matrix}$$

The following example illustrates how to calculate the current per share fair value of a company. In this example, the per share earnings is $10 and the current risk free ten-year government note rate is 5%. With these facts, the fair value is calculated to $200 or ($10 divided by 5%). If the fair value cannot be determined as the relative value to the risk free rate of a ten-year Treasury Note, then the last reported book value will be used as fair value. Alternatively, the consensus estimate for the book value may be used as the fair value. Fair value is used to determine where the intrinsic line should begin, i.e. to find its current position. FIG. 1 illustrates the current Fair Value of the stock at a starting point and a future value point at the end of a ten year period. Additionally, as illustrated in FIG. 4, a system 10 may include a computer 12 that is accessible by a user 14, which may or may not be via a network connection 16, and a database 18. As described above, the computer 10 may then calculate or determine a fair value 20 of the stock by dividing the GAAP earnings by the current risk free government note rate for a defined time period.

Step two: Annual Compounding Intrinsic Return. This is determined, for example, by a historical annual compounding rate of return of a company's relative value to the risk free rate (e.g. a ten-year Treasury Note) taking dividends and other distributions into consideration. The risk free rate may be defined as the average rate during the period (e.g. past ten years) or alternatively the current rate or actual (historical rate) or alternatively the average rate during the period (e.g. past ten years). The relative value (fair value) is calculated by dividing the annual Earnings Per Share (EPS) with the risk free rate. Dividends or other distributions are the accumulated payments during the period (duration) extending from time t₁ to time tₙ.

The annual Compounding Intrinsic Return=Future value (A) (fair value at time tₙ)+accumulated distributions including dividends Paid (B) divided by Present value (C)̂1/n−1 (fair value at time t₁).

$$Annual Compounding Intrinsic Return = {( \frac{Future Value + Accumulated Distributions}{Present Value} )}^{( \frac{1}{n} )} - 1 \qquad Equation 2$$

A) Future value=the company's historical relative value to the risk free rate (fair value) at the end of the measured period (year 10).
B) Accumulated distributions=the sum of dividend payments and other distributions during the period (10 years)
C) Present value=the company's historical relative value to the risk free rate (fair value) at the beginning of the measured period (year 1).

TABLE 1

| EXAMPLE - CALCULATION | Base | YR1 | YR2 | YR3 | YR4 | YR5 | YR6 | YR7 | YR8 | YR9 | YR10 |
|---|---|---|---|---|---|---|---|---|---|---|---|
| 10 Year Historical Records | 1995 | 1996 | 1997 | 1998 | 1999 | 2000 | 2001 | 2002 | 2003 | 2004 | 2005 |
| Annual GAAP Earings - (EPS) | $1.2 | $1.6 | $2.0 | $2.8 | $3.7 | $3.1 | $4.6 | $6.9 | $7.7 | $8.8 | 11.2 |
| Average - Risk Free Rate - Past 10 Yrs | 5.0% | 5.0% | 5.0% | 5.0% | 5.0% | 5.0% | 5.0% | 5.0% | 5.0% | 5.0% | 5.0% |
| Relative Value − Fair Value | $24.0 | $32.2 | $40.8 | $55.2 | $74.4 | $61.6 | $92.2 | $137.4 | $154.4 | $175.8 | $223.4 |
| Dividends Paid | $0.4 | $0.5 | $0.6 | $0.8 | $1.1 | $0.9 | $1.4 | $2.1 | $2.3 | $2.6 | $3.4 |
| Other distributions | $0.0 | $0.0 | $0.0 | $0.0 | $0.0 | $0.0 | $0.0 | $0.0 | $0.0 | $0.0 | $0.0 |

Future Value = relative value + accumulated dividens and other distributions during the period
Annual Compounding Intrinsic Return = 24.0 (as present value), n = 10, 239.1 (as future value)
Annual Compounding Intrinsic Return 25.8% (pre-tax return)

| | |
|---|---|
| Relative Value | 223.4 |
| Acc. Dividends - 10 Yrs | 15.7 |
| Other Distributions | 0.0 |
| Total (new future value) | 239.1 |

It is contemplated that if fair value cannot be determined as the relative value to a risk free rate, the last reported book value may be used as the fair value. If fair value (e.g. the relative value) is lower than book value, the book value will be used as fair value when determining the annual compounding intrinsic return. For example, fair value is the higher of the relative value to the risk free rate and the book value. Alternatively the consensus estimate for book value may be used as the fair value.

Further analysis could also be performed through, for example, ten, five and two year periods on the annual compounding intrinsic return to indicate if the return is increasing or decreasing. The book value, dividend, cash flow, return on equity or on total capital could alternatively be used when determining intrinsic return.

Still further, a weighing system could be applied to normalize earning by taking into account cyclical ups and downs in the business (economy) cycle.

The step of determining annual compounding intrinsic return is further illustrated as taken into account in the fair value line plot as illustrated in FIG. 1. Additionally, a company's annual compounding intrinsic return 22 is illustrated as data taken into account by computer 12 in FIG. 4.

Step three: Consistency of Intrinsic Return. This step if defined and determined by the consistency ratio of the historical annual compounding intrinsic return (e.g. the standard deviation—which is calculated through the year by year growth records of the relative value to the risk free rate (intrinsic return)—divided by, for example, the ten-year historical annual compounding intrinsic return). The consistency ratio is calculated to get a measure of relative risk.

$$Consistency = \frac{ Standard Deviation of 10 Yr ( Year by Year Growth Records ) of the Relative Value to the Risk Free Rate}{10 Yr Annual Compounding Intrinsic Return} \\ Example \text{:} \\ Hennes \& Mauritz = \frac{20.9 \%}{26.5 \%} = 0.79 \qquad Equation 3$$

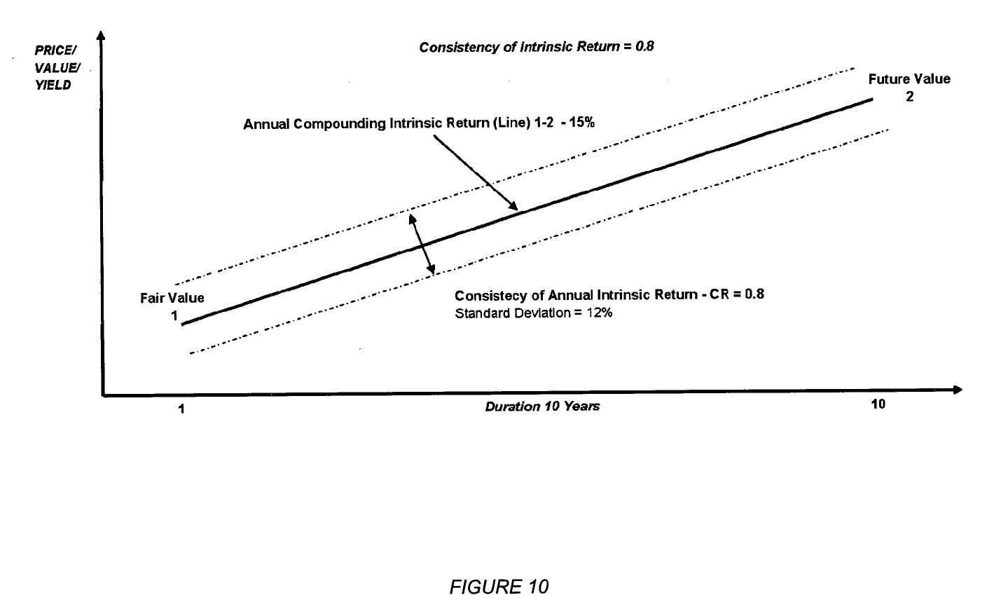

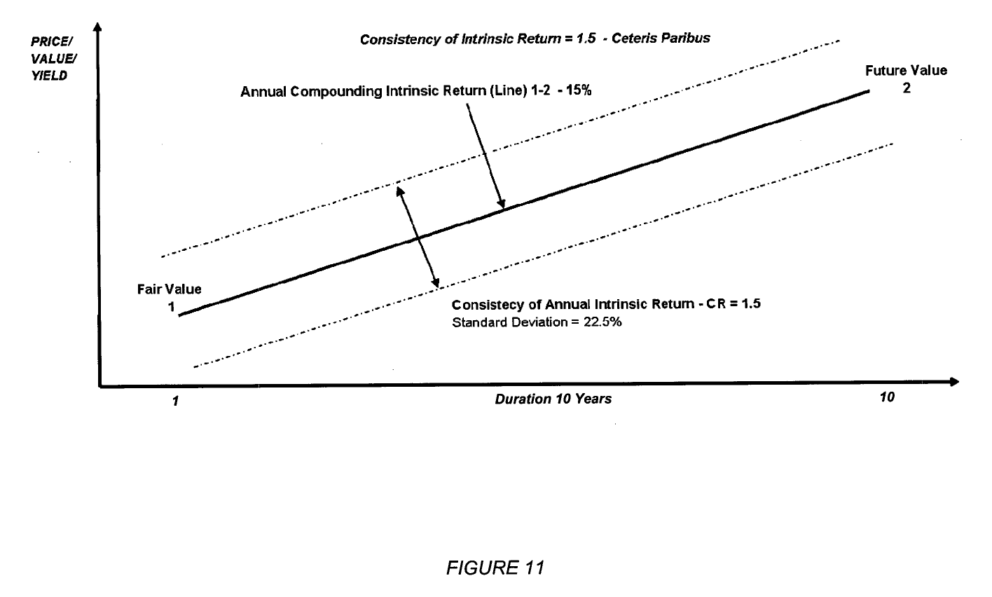

It should be noted that a higher consistency ratio translates to higher risk and vice versa. A rating system is used to classify stocks by risk. For example, a low consistency ratio translates to high predictability and therefore, a high rating. Whereas a high variation translates to low predictability and therefore, a relatively low rating. It is contemplated that additional consistency analysis may be performed through the ten, five and two year compounding return, which indicates if the consistency ratio is increasing or declining. Alternatively, other alternative measurements could be used to account for risk. As illustrated in FIGS. 10 and 11, the upper and lower lines track the fair value (Intrinsic Return Line), where with a higher rating (lower consistency ratio) the line plot would be narrower (less volatility; FIG. 10) and with the lower rating the tracking would be wider, (more volatility; FIG. 11). If the standard deviation increases, the consistency ratio increases and thereby the risk. Referring to FIG. 4, Company consistency ratio 24 is additional information provided to computer 12.

Again, as stated earlier, it is contemplated that this step of taking into account consistency of intrinsic growth could be combined with the step of determining the fair value of the stock.

Step four: Current Annual Compounding Rate of Return on Investment. This is determined by calculating the annual compounding rate of return between a current stock price and a calculated future value (fair value at time tₙ). The calculated future value may be calculated over a specified period of time, such as, for example, ten years.

$$Current ROI = {( \frac{Future Value}{Current Price} )}^{( \frac{1}{n} )} - 1 \qquad Equation 4$$

In one example, fair value of a stock it is assumed to be $200 (fair value at time t₁), and a ten-year annual compounding intrinsic return is 15% for ten years. The future value (fair value at time tₙ) is then calculated to be $808. If the current stock price, which is determined by the stock market, is $150, then the current annual return on investment is 18%. This is calculated by taking $150 as the present value, the duration of ten years, and the future value of $808. If, however, the stock price was higher, e.g. $300, the current annual compounding return on investment would be lower, calculated to 10%.

Again, FIG. 1 is a graphical illustration of the current annual compounding rate of return on investment of the stock over a period of ten years and illustrating the annual compounding intrinsic return and consistency of intrinsic return (consistency ratio). This is further illustrated in FIG. 4 where current annual compounding rate of return on investment 26 is generated by computer 12.

An alternative step one may be used where risk, based on the coefficient of risk, may be initially taken into account during the first step of determining a fair value for the stock.

First alternative to the primary method, step one: Fair Value Determination Taking into Account Risk (FIG. 1A). The step is similar to Step one as described above, except that risk (volatility) is taken into consideration, whereas the primary method rates companies based upon its consistency ratio. The first and second alternative methods account for risk when determining “fair value” (first alt. method) or alternatively when determining “intrinsic return” (second alt. method). If the company does not have a perfectly consistent record of performance (intrinsic return), a premium will be added lowering the fair value or intrinsic return.

The new risk adjusted required initial return or discount rate, is determined by a Consistency Ratio between a standard deviation and an intrinsic return. The standard deviation of historical performance (e.g. intrinsic return) is divided by the historical intrinsic return and multiplied with the risk free rate plus the risk free rate. (FIG. 1A)

$$Required Initial Return = \frac{ Standard Deviation of 10 Yr ( Year by Year Growth Records ) of the Relative Value to the Risk Free Rate}{10 Yr Annual Compounding Intrinsic Return} \times Risk Free Rate + Risk Free Rate \\ Risk Premium = Required Initial Return - Risk Free Rate \\ Example \text{:} \\ Required Initial Return = ( \frac{20.9 \%}{26.5 \%} ) \times 4.7 \% + 4.7 \% = 8.4 \% \\ Risk Premium = 8.4 \% - 4.7 = 3.7 \% \qquad Equation 5$$

For example, a standard deviation is 10%, the intrinsic return is 20% and the risk free rate is 5%. The new discount rate or initial return requirement is therefore: (0.5*5%)+5%=7.5% (risk premium is 2.5%). If a company's last reported or trailing Earnings Per Share (EPS) is $10, then the new (risk adjusted) fair value would be $10 divided by 7.5%=$133. It can be seen that the new fair value is now discounted to reflect a 100% consistent (e.g. standard deviation=0) performance record. By calculating and adding a risk premium it becomes possible to compare companies in a population on a risk adjusted basis. This makes stocks comparable to a benchmark e.g. the (risk free rate), which has a standard deviation of “0” when held to maturity. Risk is the volatility in the year by year growth records of the intrinsic return.

It should be noted, however, that other alternative measurements and adjustments could be used or applied to calculate or estimate an appropriate risk premium or required initial return as desired. For example regression analysis may be used to benchmark performance (e.g. bond market) or some other alternative methods may also be used.

in the alternative method, the second step of determining annual compounding intrinsic return is the same as described above and the third step of determining consistency of intrinsic return has already been accomplished in alternative step one.

Second alternative to the primary method (FIG. 1B). The annual compounding intrinsic return is determined by adjusting the annual compounding intrinsic return for the relative risk calculated by the first alternative method. The new adjusted annual compounding intrinsic return is calculated by using A) the fair value according to the primary method and B) the future value according to first alternative method.

This second alternative method is another method of adjusting for relative risk. Instead of adjusting fair value (adding a risk premium) according to the first alternative method, the intrinsic return is adjusted and uses the same fair value as per the primary method. It should be noted that the end result is the same as using the first alternative method. One advantage of this method sequencing, however, is that the system could use the same fair value determination as the primary method. A graphical illustration of the second alternative method is provided in FIG. 1B.

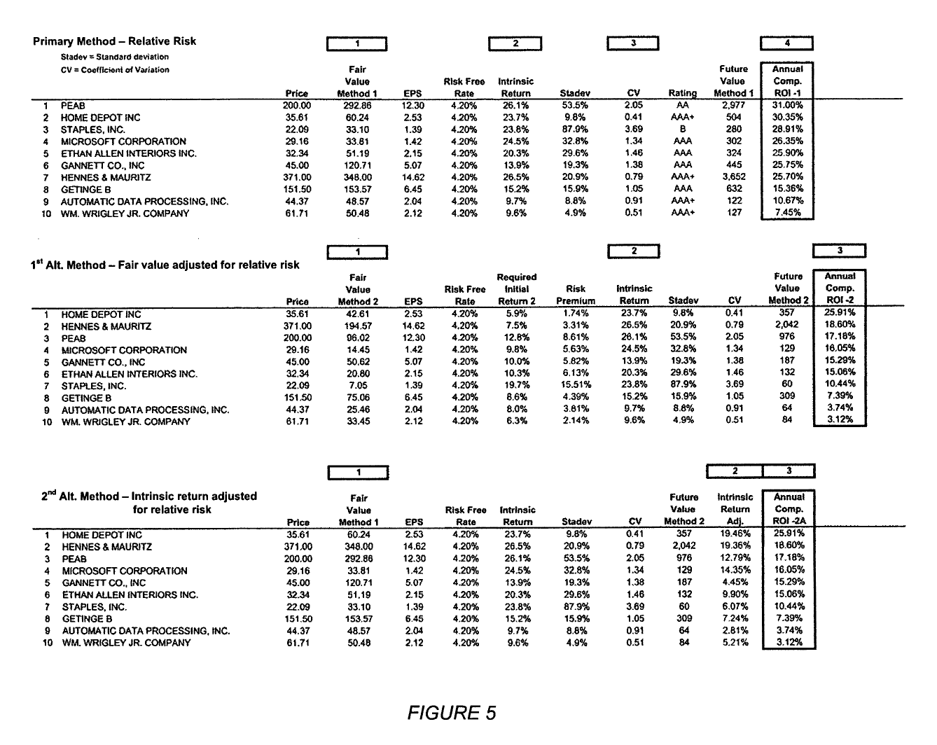

A chart is provided in FIG. 5 illustrating the application of the primary method, the first alternative method and the second alternative method showing the differing current annual compounding rate of return on investment. It should be noted, however, that the first and the second alternative methods yield the same end result.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

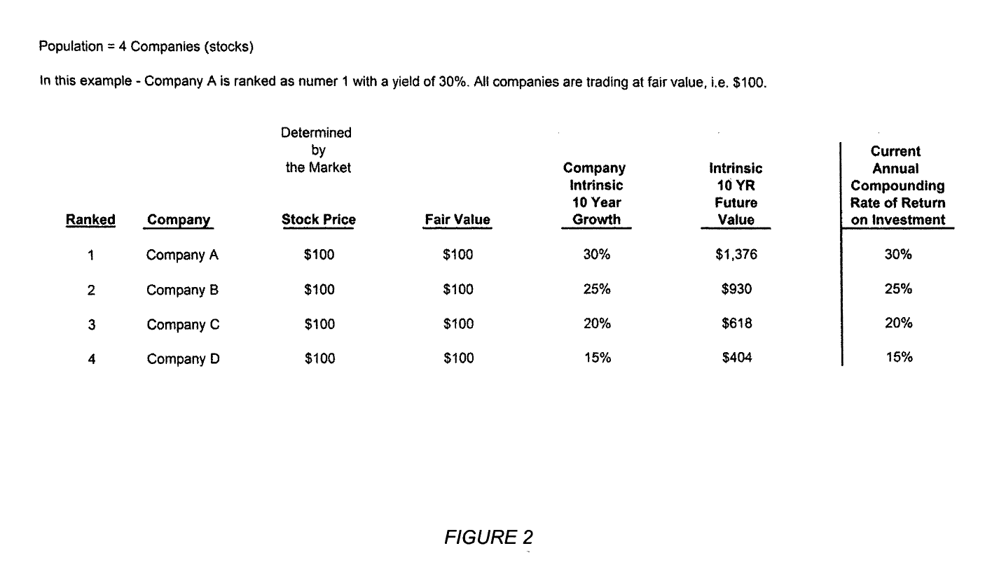

Referring now to FIGS. 2-3 and 6, it is additionally contemplated that a method for determining the fair value of stocks in a population (e.g. an index), may be based on a ranking system generated by a computer that calculates the top ranked company based on its current annual compounding rate of return on investment according to the method described above as illustrated in FIG. 2.

It is contemplated that the company with the highest current annual compounding rate of return on investment will, at any given moment, be the top ranked company in the index.

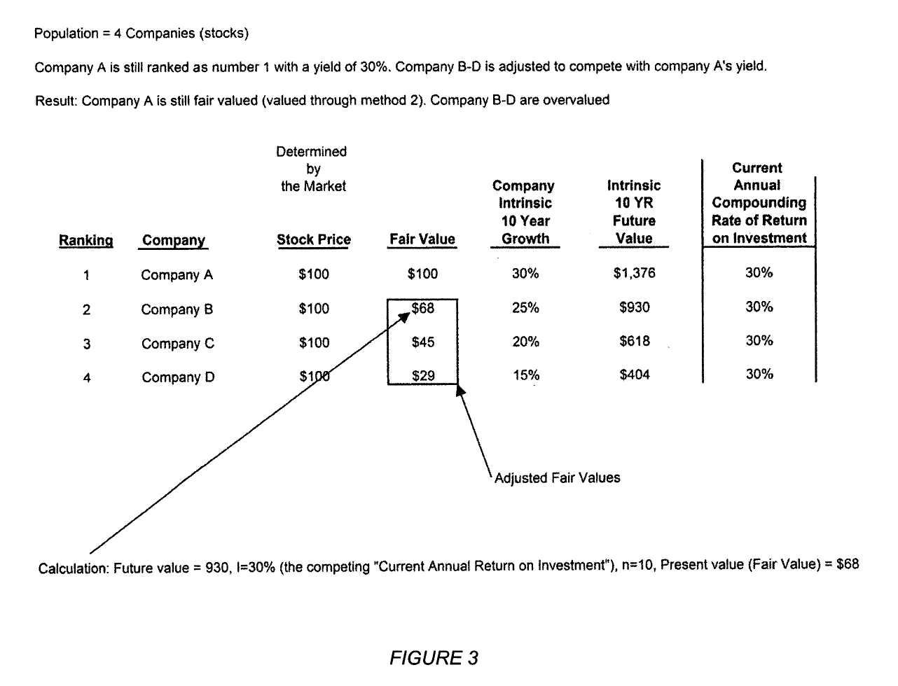

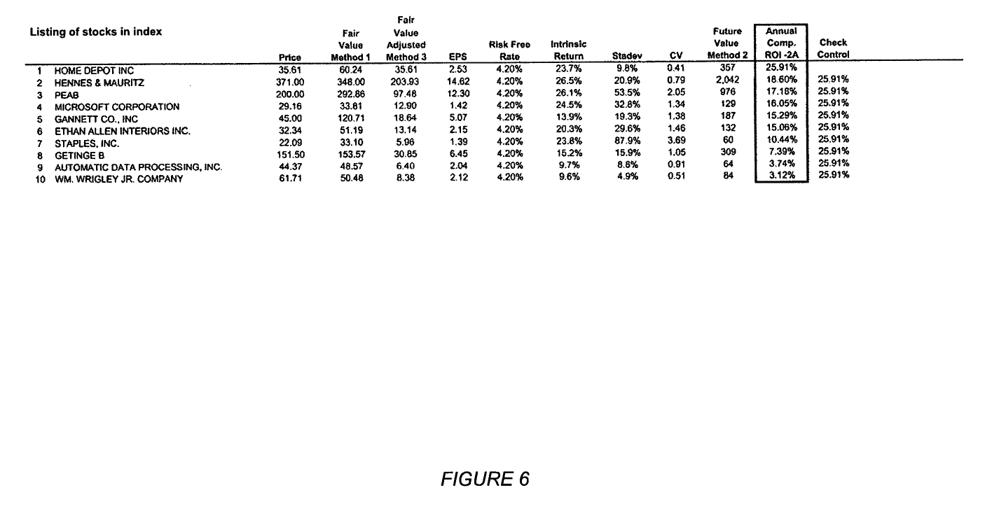

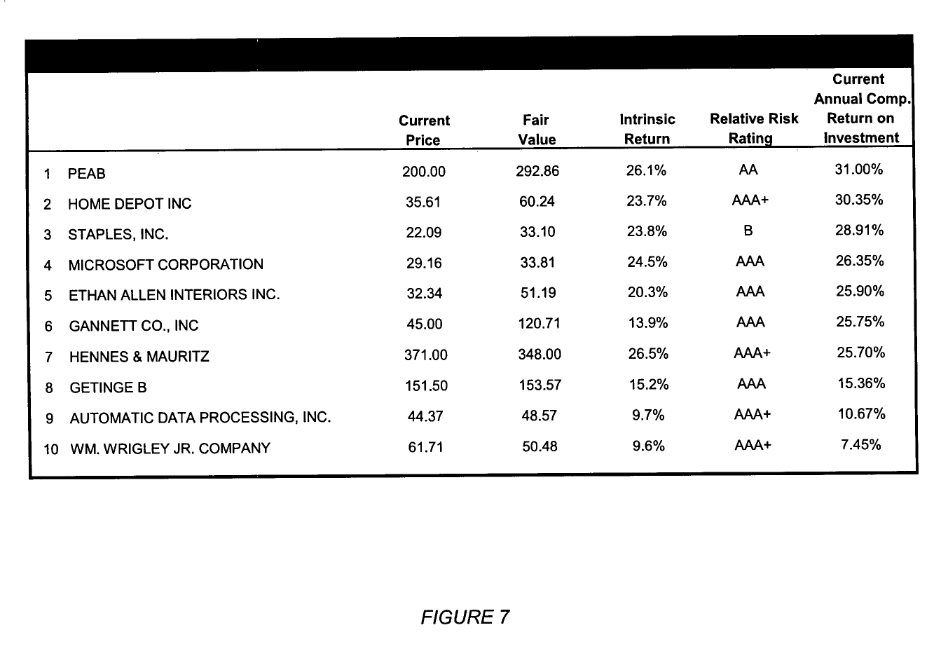

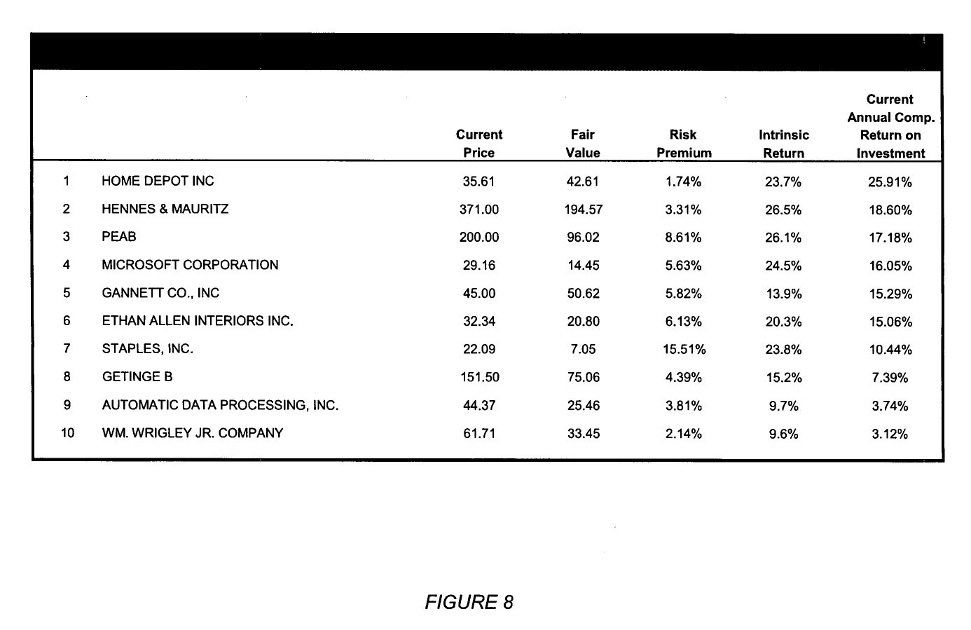

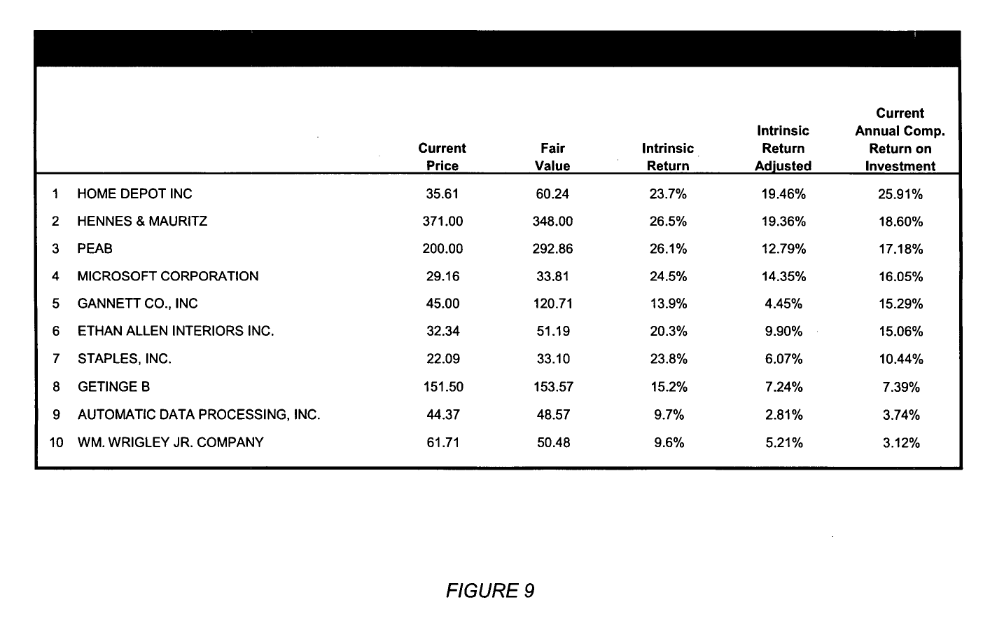

When all the companies have been ranked according to their current annual compounding rate of return on investment, it is contemplated that the fair value for the remaining companies may then be adjusted or recalculated as illustrated in FIG. 3. As listing of current annual compounding rate of return on investment 28 is an optional feature to system 10, it is illustrated as a dashed line in FIG. 4 and further illustrated in FIGS. 6-9. For example, the companies illustrated in FIG. 7 are listed according to current annual compounding return on investment, while FIG. 8 shows the fair value adjustment for relative risk, while FIG. 9 shows the intrinsic return adjusted for relative risk.

The top ranked company, e.g. the company that has the highest current annual compounding rate of return on investment, may be used to adjust or determine the fair value for the remaining companies in real time to provide the most accurate and up to date information for the user. The fair value may be determined by adjusting the fair value to yield a similar or competitive current annual compounding rate of return on investment as the number one ranked company. This is realistically taken into account because all investments compete with the rate of return on a risk free investment (e.g. a benchmark) and all investments compete with one another.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A method for determining the profitability on stock investments comprising the steps of:
calculating a current fair value of a stock by one of the following steps:
determining a relative value by dividing a Rolling EPS by a Risk Free Rate averaged over a time (T), where Rolling EPS is a Rolling Earnings Per Share and is a measurement of a company's EPS over a time period (T1); or
selecting a book value of the stock that is determined to be the same as a last reported book value of the stock; or
selecting a book value estimate of the stock that is a consensus estimate for the book value of the stock;
calculating an annual compounding intrinsic return according to the following equation:
$${( \frac{Future Value + Accumulated Distributions}{Present Value} )}^{( \frac{1}{n} )} - 1$$
where Future Value is a company's historical relative value to the Risk Free Rate at the end of a ten-year period; Accumulated Distributions is a sum of dividend payments and other distributions during the ten-year period; and Present Value is a company's historical relative value to the Risk Free Rate at a beginning of the ten-year period;
determining a consistency of intrinsic return rate by dividing a Standard Deviation of the Annual Compounding Intrinsic Return from year to year during the ten-year period by a ten-year Annual Compounding Intrinsic Return;
generating a current annual compounding rate of return on investment according to the following equation:
$${( \frac{Future Value}{Current Price} )}^{( \frac{1}{n} )} - 1$$
where Current Price is a current stock price.

2. The method according to claim 1 wherein the current fair value of a stock is determined by the higher of the relative value, the book value or the book value estimate.

3. The method according to claim 1 wherein the step of determining the consistency of intrinsic return further includes determining a consistency ratio of the historical annual compounding return rate in earnings over the period.

4. The method according to claim 3 wherein the consistency ratio is expressed as a factor.

5. The method according to claim 4 further comprising the step of generating a rating system based on a relative consistency determined by the consistency ratio in a population of stocks.

6. The method according to claim 1 wherein the step of generating the current annual compounding rate of return on investment further includes calculating the annual compounding rate of return on investment between a current stock price and the calculated intrinsic value over the ten-year period.

7. The method according to claim 1 further comprising the step of generating a listing of stocks based on the calculated annual compounding rate of return on investment.

8. The method according to claim 7 wherein the listing provides a ranking of the stocks with the stock having the highest current annual compounding rate of return having the highest ranking.

9. The method according to claim 8 further comprising the step of recalculating in real time the fair value of all the stock on the listing under the highest ranked stock.

10. The method according to claim 1 wherein the step of calculating the fair value of a stock further includes multiplying a consistency ratio of an annual compounding intrinsic return of a company to which a stock is associated by a risk free government note rate to generate a risk premium.

11. The method according to claim 10 where the risk premium is added to the risk free rate to determine a discount rate.

12. The method according to claim 1 wherein the step of calculating an annual compounding intrinsic return further includes multiplying a consistency ratio of an annual compounding intrinsic return of a company to which a stock is associated by a risk free government note rate to generate a risk premium.

13. The method according to claim 12 where the risk premium is added to the risk free rate to determine a discount rate.

14. A system for determining the profitability on stock investments comprising:
a computer having a network connection;
a database of information relating to stocks and accessible by said computer;
software executing on said computer calculating a fair value of a stock according to one of the following:
determining a relative value by dividing a Rolling EPS by a Risk Free Rate averaged over a time (T), where Rolling EPS is a Rolling Earnings Per Share and is a measurement of a company's EPS over a time period (T1); or
selecting a book value of the stock that is determined to be the same as a last reported book value of the stock; or
selecting a book value estimate of the stock that is a consensus estimate for the book value of the stock;
software executing on said computer calculating an annual compounding intrinsic return on investment according to the following equation:
$${( \frac{Future Value + Accumulated Distributions}{Present Value} )}^{( \frac{1}{n} )} - 1$$
where Future Value is a company's historical relative value to the Risk Free Rate at the end of a ten-year period; Accumulated Distributions is a sum of dividend payments and other distributions during the ten-year period; and Present Value is a company's historical relative value to the Risk Free Rate at a beginning of the ten-year period;
software executing on said computer determining a consistency of intrinsic return rate by dividing a Standard Deviation of the Annual Compounding Intrinsic Return from year to year during the ten-year period by a ten-year Annual Compounding Intrinsic Return;
software executing on said computer generating a current annual compounding rate of return on investment according to the following equation:
$${( \frac{Future Value}{Current Price} )}^{( \frac{1}{n} )} - 1$$
where Current Price is a current stock price.

15. The system according to claim 14 wherein the current fair value of a stock is determined by the higher of the relative value, the book value or the book value estimate.

16. The system according to claim 14 wherein said consistency of intrinsic return rate further includes a consistency ratio of a historical annual compounding return rate in earnings over the period.

17. The system according to claim 16 wherein the consistency ratio is expressed as a factor.

18. The system according to claim 14 wherein said current annual compounding rate of return on investment further includes calculating an annual compounding rate of return between a current stock price and the calculated intrinsic value over the ten-year period.

19. The system according to claim 14 further comprising a listing of stocks based on the calculated annual compounding rate of return on investment of the stocks.

20. The system according to claim 19 wherein the listing provides a ranking of the stocks with the stock having the highest current annual compounding rate of return having the highest ranking.

21. The system according to claim 20 wherein the fair value of all the stocks on the listing under the highest ranked stock are recalculated in real time.

22. The system according to claim 14 said fair value of a stock is further derived by multiplying a consistency ratio of an annual compounding intrinsic return of a company to which a stock is associated by a risk free government note rate to generate a risk premium.

23. The system according to claim 22 where the risk premium is added to the risk free rate to determine a discount rate.

24. The method according to claim 14 wherein the step of calculating an annual compounding intrinsic return further includes multiplying a consistency ratio of an annual compounding intrinsic return of a company to which a stock is associated by a risk free government note rate to generate a risk premium.

25. The method according to claim 24 where the risk premium is added to the risk free rate to determine a discount rate.

26. A method for determining the profitability on stock investments comprising the steps of:
calculating a fair value of a stock by one of the following steps:
determining a relative value by dividing a Rolling EPS by a Risk Free Rate averaged over a time (T), where Rolling EPS is a Rolling Earnings Per Share and is a measurement of a company's EPS over a time period (T1); or
selecting a book value of the stock that is determined to be the same as a last reported book value of the stock; or
selecting a book value estimate of the stock that is a consensus estimate for the book value of the stock;
calculating an annual compounding intrinsic return by adding a calculated fair value of the stock at time (tₙ) with a sum of payments and distributions during the period of time (t) and dividing the sum by a calculated fair value at time (t₁);
determining a consistency of intrinsic return rate by dividing a standard deviation comparison of the intrinsic return for discrete periods of time during time (t) by a historical annual compounding intrinsic return over time (t); and
generating a current annual compounding rate of return on investment for the stock by dividing a future value by a current stock price, where the future value is a company's historical relative value to the risk free rate at time (tₙ).

27. The method according to claim 26 wherein the period of time is selected from the group consisting of: ten years, five years and two years.

28. The method according to claim 26 wherein the step of calculating the consistency of intrinsic return further includes determining a consistency ratio of the historical annual compounding intrinsic return over the period of time.

29. The method according to claim 26 wherein the consistency ratio is expressed as a factor.

30. The method according to claim 26 further comprising the step of generating a listing of stocks based on the calculated annual compounding rate of return on investment.

31. The method according to claim 30 wherein the listing provides a ranking of the stocks with the stock having the highest current annual compounding rate of return on investment having the highest ranking.

32. The method according to claim 31 further comprising the step of recalculating in real time the fair value of all the stocks on the listing under the highest ranked stock.

33. The method according to claim 30 wherein the listing provides a rating of the stocks by consistency ratio.

34. The method according to claim 26 wherein the step of calculating the fair value of a stock further includes multiplying a consistency ratio of an annual compounding intrinsic return of a company to which a stock is associated by a risk free government note rate to generate a risk premium.

35. The method according to claim 34 where the risk premium is added to the risk free rate to determine a discount rate.

36. The method according to claim 26 wherein the step of generating the current annual compounding rate of return on investment is generated according to the following equation:
$${( \frac{Future Value}{Current Price} )}^{( \frac{1}{n} )} - 1$$
where Current Price is the current stock price.

37. The method according to claim 26 wherein the current fair value of a stock is determined by the higher of the relative value, the book value or the book value estimate.

38. The method according to claim 26 wherein the step of calculating an annual compounding intrinsic return further includes multiplying a consistency ratio of an annual compounding intrinsic return of a company to which a stock is associated by a risk free government note rate to generate a risk premium.

39. The method according to claim 38 where the risk premium is added to the risk free rate to determine a discount rate.

40. A system for determining the profitability on stock investments comprising:
a computer having a network connection;
a database of information relating to stocks and accessible by said computer;
software executing on said computer calculating a fair value of a stock according to one of the following:
determining a relative value by dividing a Rolling EPS by a Risk Free Rate averaged over a time (T), where Rolling EPS is a Rolling Earnings Per Share and is a measurement of a company's EPS over a time period (T1); or
selecting a book value of the stock that is determined to be the same as a last reported book value of the stock; or
selecting a book value estimate of the stock that is a consensus estimate for the book value of the stock;
software executing on said computer calculating an annual compounding intrinsic return by adding a calculated fair value of the stock at time (tₙ) with a sum of payments and distributions during the period of time (t) and dividing the sum by a calculated fair value at time (t₁);
software executing on said computer determining a consistency of intrinsic return rate by dividing a standard deviation comparison of the intrinsic return for discrete periods of time during time (t) by a historical annual compounding intrinsic return over time (t); and
software executing on said computer generating a current annual compounding rate of return on investment for the stock by dividing a future value by a current stock price, where the future value is a company's historical relative value to the risk free rate at time (tₙ).

41. The system according to claim 40 wherein the current fair value of a stock is determined by the higher of the relative value, the book value or the book value estimate.

42. The system according to claim 40 wherein the period of time is selected from the group consisting of: ten years, five years and two years.

43. The system according to claim 40 wherein said consistency of intrinsic return rate further includes a consistency ratio of a historical annual compounding intrinsic return over the period of time.

44. The system according to claim 43 wherein the consistency ratio is expressed as a factor.

45. The system according to claim 40 wherein said current annual compounding rate of return on investment for the stock further includes calculating an annual compounding rate of return between a current stock price and a calculated intrinsic value over the period.

46. The system according to claim 40 further comprising a listing of stocks based on the calculated annual compounding rate of return on investment of the stocks.

47. The system according to claim 46 wherein the listing provides a ranking of the stocks with the stock having the highest current annual compounding rate of return on investment having the highest ranking.

48. The system according to claim 46 wherein the fair value of all the stocks on the listing under the highest ranked stock are recalculated in real time.

49. The system according to claim 40 said fair value of a stock is further derived by multiplying a consistency ratio of an annual compounding intrinsic return of a company to which a stock is associated by a risk free government note rate to generate a discount rate.

50. The system according to claim 40 wherein said software executing on said computer generates the current annual compounding rate of return on investment according to the following equation:
$${( \frac{Future Value}{Current Price} )}^{( \frac{1}{n} )} - 1$$
where Current Price is the current stock price.
